(19) United States
(12) Patent Application Publication
(10) Pub. No.: US 2017/0089312 A1
(43) Pub. Date: Mar. 30, 2017

(54) Fuel Injector

(71) Applicant: Delphi International Operations Luxembourg S.A.R.L., Bascharage (LU)

(72) Inventors: Philippe Legrand, St. Gervais La Foret (FR); Jean-Christophe Oge, Neuvy (FR)

(21) Appl. No.: 15/310,484

(22) PCT Filed: Apr. 21, 2015
(86) PCT No.: PCT/EP2015/058549

§ 371 Date: Nov. 11, 2016

(30) Foreign Application Priority Data
May 13, 2014 (GB) 1408422.2

(51) Int. Cl. F02M 61/12; F02M 61/16; F02M 61/20

(52) U.S. Cl. CPC F02M 61/12; F02M 61/205; F02M 61/165; F02M 2200/27; F02M 2200/28

(57) ABSTRACT

A nozzle assembly of a fuel injector extends along a main axis and includes a nozzle body provided with an inner space divided in upstream chamber and downstream chamber and also with, a valve needle including a main elongated shaft slidably guided in said inner space and extending through-out both upstream and downstream chambers. The nozzle body and the valve needle cooperate to define throttle fluid communication means between upstream and downstream chambers inducing, in use, a pressure drop when fuel flows through. The nozzle assembly is further provided with a tubular sleeve arranged between the upstream chamber and the downstream chamber in abutment against a face of the body and being radially self-centred guided by a cylindrical face of the needle, the throttle means being arranged in said sleeve.

### CROSS REFERENCE TO RELATED APPLICATIONS

This application is a national stage application under 35 USC 371 of PCT Application No. PCT/EP2015/058549 having an international filing date of Apr. 21, 2015, which is designated in the United States and which claimed the benefit of GB Patent Application No. 1408422.2 filed on May 13, 2014 the entire disclosures of each are hereby incorporated by reference in their entirety.

### TECHNICAL FIELD

The present invention relates to a fuel injector and more particularly to a nozzle motion control feature arranged in said injector.

### BACKGROUND OF THE INVENTION

Fuel injector of the prior art are disclosed in EP0844383 and in EP0971118 and, a known embodiment is also partially presented on FIGS. 1 and 2. This fuel injector 10 extends along a main axis A and it is provided with a nozzle assembly 12 comprising a hydraulically controlled valve needle 14 slidably arranged in a nozzle body 16. The valve needle 14 axially A displaces under the influence of fuel pressure differences inducing forces on upstream faces 18, 20, and downstream faces 22, 24, of the needle 14. To induce said pressure difference the injector 10 is provided with a control valve, not shown, closing or opening an outlet of a control chamber 26 wherein pressure alternatively builds-up and down, the upper part of the valve needle 14 protruding in said control chamber 26 and also, with a throttle orifice 28 through which the pressurized fuel flows toward injection holes 30, said throttle 28 generating a pressure drop.

In the injector of FIG. 1, the throttle 28 is an annular clearance between the inner face 32 of the nozzle body 16 and the outer edge 34 of a collar 36, also known as “boost flange” or “NMC” (nozzle motion control), radially extending from the valve needle 14.

In use, upon the operating condition of an internal combustion engine, the pressure of the fuel flowing in the injectors 10 varies in a large range extending from few bars to several thousands of bars and, consequently the nozzle body 16 expends slightly reducing or increasing the throttle 28 and, affecting the operating performances of the injector 10.

### SUMMARY OF THE INVENTION

Accordingly, it is an object of the present invention to resolve the above mentioned problems in providing a nozzle assembly of a fuel injector. The nozzle assembly extends along a main axis from upstream end to downstream end, in reference to the fuel flow direction in an injector, said nozzle assembly comprising a nozzle body provided with an inner space divided in upstream chamber and downstream chamber and also with, a valve needle comprising a main elongated shaft slidably guided in said inner space. The needle extends through-out both upstream and downstream chambers, the nozzle body and the valve needle advantageously cooperating to define throttle fluid communication means between upstream and downstream chambers inducing, in use, a pressure drop when fuel flows through said throttle means.

The nozzle assembly is further provided with a tubular sleeve, having a central hole through which extends the needle, the sleeve, being arranged between the upstream chamber and the downstream chamber in abutment against a face of the body, respectively of the needle, and being radially self-centred guided by a cylindrical face of the needle, respectively the body, the throttle means being arranged in said sleeve.

The valve needle is provided with a collar radially outwardly extending from its main shaft to a peripheral edge, the sleeve being providing with a central hole and being in axial abutment against a face of the nozzle body. The sleeve being also radially self-centred guided by said peripheral edge. The throttle means is an orifice drilled through the sleeve and extending from an upstream orifice opening in the upstream chamber to a downstream orifice opening in the downstream chamber.

The sleeve is tubular and axially elongated, the throttle being drilled through the lateral wall of the tubular sleeve, the upstream orifice being arranged in the outer cylindrical face of the sleeve and, the downstream orifice being arranged in the inner cylindrical face of the sleeve.

Alternatively, the sleeve may be provided with a multitude of fine through holes so that, the sleeve provides, in use, pressure drop and, is also a fuel filter retaining foreign matters and particles flowing in the fuel.

Also, the downstream end of the tubular sleeve is bevelled so that the abutting portion of the sleeve against the face of the nozzle body is reduced.

The collar is guided toward the upstream end of the tubular sleeve, the downstream opening of the throttle being toward the downstream end of the sleeve, downstream the collar.

In an alternative embodiment, the sleeve may be a thick disc-plate radially extending from the central hole. The throttle is drilled through the thickness of the sleeve and, its upstream orifice is arranged in the upper face of the sleeve and, its downstream orifice being arranged in the lower face of the sleeve.

The lower face of the disc-place sleeve is provided with a recess defining a circular bevelled protrusion, such as a peripheral lip, so that the abutting portion of the sleeve is reduced or, alternatively, the face of the nozzle body against which abuts the sleeve is provided with a circular bevelled protrusion, such as a peripheral lip upwardly protruding, so that the abutting portion of the sleeve is reduced.

In another embodiment, the sleeve is a thick disc-plate having a central hole larger than the needle shaft, the sleeve radially extending from said hole to an outer peripheral face slidably guided and self-centred by the inner cylindrical face of the nozzle. The valve needle is provided with a radially extending face which outer edge is larger than the central hole of the sleeve so that, the sleeve is received in axial abutment against said radial face of the needle. The throttle means comprise an orifice drilled through the thickness of said disc-sleeve and extending from the upper face to the lower face of the sleeve.

In any embodiment, the nozzle assembly may further comprise biasing means arranged to axially bias the sleeve, downstream against the face, of the body, or of the needle.

The biasing means can be a compression spring coiled around the needle shaft and compressed between the sleeve, and an upper radial face of the needle or, it can be a spring compressed between the sleeve, and the inner face of the upstream chamber, the spring having a larger section upstream, where it is stuck against said inner face, than downstream, where it is in contact with the sleeve.

In any embodiment, the throttle means may comprise a plurality of orifices provided through the sleeve also, the upstream orifice of the throttle can be of a larger section that the downstream orifice.

The invention further extends to a fuel injector provided with a nozzle assembly as previously described.

### BRIEF DESCRIPTION OF THE DRAWINGS

The present invention is now described by way of example with reference to the accompanying drawings in which:

FIG. 1 is an axial section of a nozzle assembly of a fuel injector of the prior art.

FIG. 2 is a magnified view of the nozzle motion control feature of the injector of FIG. 1.

FIG. 3 is a first embodiment of a nozzle motion control feature as per the invention.

FIG. 4 is an alternative to the first embodiment of FIG. 3.

FIG. 5 is a second embodiment of a nozzle motion control feature as per the invention.

FIG. 6 is an alternative construction of the second embodiment of FIG. 5.

FIG. 7 is a third embodiment of a nozzle motion control feature as per the invention.

FIG. 12 is yet another alternative for fixing the electrical terminal in the connector body.

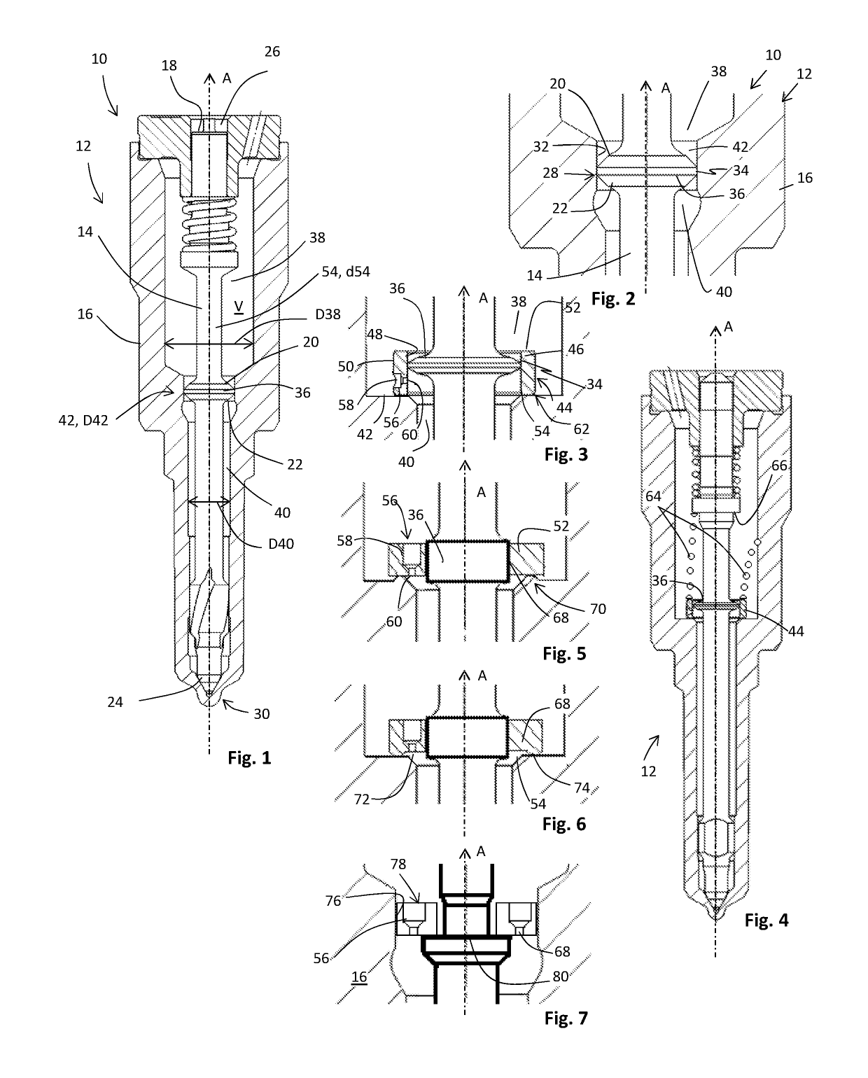

### DESCRIPTION OF THE PREFERRED EMBODIMENTS

To ease and clarify the following description the top-down orientation of the figures is arbitrarily chosen and, words and expressions such as “above, under, over, below . . . ” may be utilized without any intention to limit the invention. Also, similar features full filling similar functions in different embodiments may be identified with same reference numbers.

In reference to FIG. 3 is described a first embodiment of a nozzle assembly 12 wherein a nozzle body 16 extends along a main axis A and is provided with an internal cylindrical bore defining inner volume V in which is slidably arranged a valve needle 14.

The inner volume V of the nozzle body 16 comprises an upstream chamber 38, represented on the upper side of the figure, having an upstream diameter D38 and, a downstream chamber 40, on the lower side of the figure, having a downstream diameter D40, smaller than the upstream diameter D38. The bottom face of the upstream chamber 38 is a disc-face 42 wherein centrally opens the downstream chamber 40.

Further means to delimit the upstream chamber 38 from the downstream chamber 40 is provided by a collar 36 integral, or independent and fixed, to the valve needle 14, said collar 36 cooperating with a tubular cylindrical sleeve 44. As shown on FIG. 3, the sleeve 44 is axially placed on the bottom disc-face 42 and is radially set and self-centred by the peripheral face 34 of the collar 36. The wall 46 of the sleeve 44 defines an inner cylindrical face 48, against which slides the collar 36, and an outer cylindrical face 50. The wall 46 axially extends between an upper face 52 and a lower face 54 positioned on the bottom disc-face 42. In the bottom part of the wall 46 the sleeve 44 is provided with a throttle orifice 56 drilled through the wall 46 and extending from an upstream orifice 58 opening in the outer face 50 of the wall 46 to a downstream orifice 60 opening in the inner face 48 of the wall 46, in the downstream chamber 40 below the collar 36. While other arrangements can be derived from this example, in the present embodiment the upstream opening 58 has a larger section than the downstream opening 60 and, the lower face 54 of the sleeve is provided with a bevelled shape 62 that reduces the contacting area between the sleeve 44 and the bottom disc-face 42. Furthermore, on FIG. 3 the throttle is represented as radially extending through the wall of the sleeve. Alternative orientations can be chosen. For instance an horizontal tilt of the throttle axis may create a swirl to the flow going through said throttle, avoiding to induce direct radial forces on the needle.

In an alternative and symmetrical design, not represented, the bevelled portion of the sleeve is provided on the lower-inner face of said sleeve, while on FIG. 3 it is represented on the lower-outer face.

Sliding of the outer face 34 of the collar 36 against the inner face 48 of the sleeve 46 still manages a minor functional clearance between the two cylindrical surfaces. Said functional clearance is so much smaller than the throttle orifice 56 then no fuel is able to flow through said clearance. All fuel flowing from the upstream chamber 38 to the downstream chamber 40 flows through the throttle orifice 56.

In use, pressurized fuel fills the upstream chamber 38 then flows through the throttle orifice 56 to enter the downstream chamber 40 where from it exits via injection holes 30. The valve needle 14 axially slides between open and closed position of the injection holes 30 and so, the collar 36 slides inside the sleeve 44.

The throttle 56 induces a pressure drop so the pressure in the downstream chamber 40 is lower than it is in the upstream chamber 38. Consequently the higher pressure of the upstream chamber 38 induces on the upper face 52 of the sleeve 44 downwardly oriented forces biasing the sleeve 44 in abutment against the bottom disc-face 42. For securing the axial abutment of the sleeve 44 against the bottom disc-face 42, one can add biasing means 64 inducing further downward forces on the sleeve 44. Examples are illustrated on FIG. 4 where, on the left side of the figure, the biasing means 64 is a coil spring compressed between the upper face 52 of the sleeve and a downwardly oriented radial face 66 of the valve needle 14, said radial face 66 being in this example, the under face of the main spring seat. The main spring downwardly biases the needle with high force and, the biasing means 64 upwardly biases the needle with much smaller forces just sufficient to hold the sleeve in place.

In an alternative embodiment illustrated on the right side of FIG. 4, the biasing means 64 is a spring that upwardly enlarges toward its upper end that is stuck against the inner face of the upstream chamber 38. Here again, the forces generated by said biasing means 64 are relatively minor and just sufficient to secure the axial positioning of the sleeve 44. Also, although only one throttle orifice 56 is shown, the sleeve could be provided with a plurality, two, three or more, throttle orifices.

In an alternative embodiment, not represented, the few throttle orifices described above are replaced by a large number of very fine holes arranged through the wall of the sleeve. Said multitude of holes provides a similar pressure drop as the few orifices described above. As an additional combined function, said multitude of fine holes create a filter stopping foreign matters, particles and other contaminants that may be in the fuel and prevent said foreign matters to flow toward the injection holes.

A second embodiment of the invention is now described in reference to FIG. 5 where further means to delimit the upstream chamber 38 from the downstream chamber 40 is provided by a collar 36 of the valve needle 14 cooperating with a thick disc-plate sleeve 68. As shown on FIG. 5, said thick sleeve 68 is axially set in abutment on the bottom disc-face 42 and is radially set as self-centred by the peripheral face 34 of the collar 36. The throttle orifice 56 is drilled through the thickness of the sleeve 68 and extends from the upper face 52 of the sleeve to the opposed lower face 54. Also, the upper end of the downstream chamber 40 is chamfered enlarging its section and, the opening of said downstream chamber 40 in the bottom disc-face 42 is surrounded by a small inverted V-shape protrusion 70 on the top of which is placed the thick sleeve 68.

In use, the operation of this second embodiment is similar to the operation of the previously described first embodiment. The downwardly oriented forces induced by the pressure in the upstream chamber 38 maintain the sleeve 68 in place. Here again, should it be felt necessary to secure said position, biasing means 64 such as the compression springs of FIG. 4 could easily be implemented in similar manners as described above.

An alternative to the second embodiment is represented on FIG. 6 where the only difference with the above description is the contact area between the sleeve 68 and the bottom disc-face 42. Here, the bottom disc-face 42 is flat and the sleeve 68 is provided on its lower face 54 with a recess 72 externally surrounded by a small peripheral lip 74 minimizing the contact area between the sleeve 68 and the bottom disc-face 42. An advantage of this alternative may reside in the manufacturing process where the recess 72 may be easier to make than the V-shape protrusion 70 described above.

A third embodiment is now described in reference to FIG. 7 where the thick disc-plate sleeve 68 is axially slidably externally guided by an inner cylindrical face 76 of body 16. The sleeve 68 is provided with an axial central hole 78 through which freely extends the needle 14, the sleeve 68 axially resting on a radially extending face 80 protruding from the needle 14. Similarly as described above, the throttle 56 extends through the thickness of the sleeve 68. An alternative to said third embodiment is to provide the radially extending face 80 against which abuts the thick sleeve 68 with one or more small passage creating a throttle restriction enabling the fuel to flow between the thick sleeve 68 and the abutting surface 80.

Also, in this embodiment again, biasing means such as the springs of FIG. 4 could enable to secure the axial position of the sleeve 68 against the radial face 80. Furthermore, as in any of the previous embodiments, the sleeve 68, here represented be provided with a plurality of throttle openings.

In use, the higher pressure of the upstream chamber 38 induces on the sleeve 68 downwardly oriented forces that bias said sleeve 68 on the radial face 80 of the needle 14. As the needle 14 slides up and down between the open and closed position the sleeve 68 follows said motion.

Furthermore, in an alternative embodiment, instead of having a throttle orifice drilled through the sleeve 44, a throttle passage can be defined in providing the collar 36 with at least one flat portion axially extending on the outer surface of the collar 36, a throttle passage being defined between said flat portion and the cylindrical inner face 48 of the sleeve 44. Alternatively to a flat portion, the outer surface of the collar 36 could be provided with an under-cut, a slot or a hole intersecting said outer surface of the collar 36, such as a semi-circular or triangular hole, defining the throttle passage 56. Alternatively, said slots can be arranged on the inner face of the sleeve.

The following references have been utilized in this description:

A main axis

V inner volume of the nozzle body

d34 edge diameter

D38 diameter of the upstream chamber

D40 diameter of the downstream chamber

10 fuel injector

12 nozzle assembly

14 valve needle

16 nozzle body

18 upstream face of the needle

20 upstream face of the collar

22 downstream face of the collar

24 downstream face of the needle

26 control chamber

28 throttle

30 injection holes

32 inner face of the body

34 outer edge of a collar

36 collar

38 upstream chamber

40 downstream chamber

42 bottom face of the upstream chamber

44 tubular sleeve

46 wall of the sleeve

48 inner cylindrical face of the sleeve

50 outer cylindrical face of the sleeve

52 upper face of the sleeve

54 lower face of the sleeve

56 throttle orifice

58 upstream opening of the throttle

60 downstream opening of the throttle

62 bevelled shape of the sleeve

64 biasing means

66 downwardly oriented radial face

68 disc-plate thick sleeve

70 V-shaped protrusion

72 recess in the lower face of the sleeve

74 peripheral lip

76 inner cylindrical face of the body axially guiding the sleeve

78 central hole of the sleeve

80 radial abutting face

1-16. (canceled)

17. A nozzle assembly of a fuel injector, the nozzle assembly extending along a main axis from upstream end to downstream end, in reference to the fuel flow direction in the fuel injector, said nozzle assembly comprising:
a nozzle body provided with an inner space divided in an upstream chamber and a downstream chamber,
a valve needle comprising a main elongated shaft slidably guided in said inner space and extending through-out both the upstream chamber and the downstream chamber, the nozzle body and the valve needle cooperating to define a throttle fluid communication means between the upstream chamber and the downstream chamber inducing, in use, a pressure drop when fuel flows through said throttle fluid communication means,
a tubular sleeve having a central hole through which extends the valve needle, the tubular sleeve being arranged between the upstream chamber and the downstream chamber in abutment against a face of the nozzle body, respectively of the valve needle, and being radially self-centred guided by a cylindrical face of the valve needle, respectively the nozzle body, the throttle fluid communication means being arranged in said tubular sleeve.

18. A nozzle assembly as set in claim 17 wherein said the valve needle is provided with a collar radially outwardly extending from the main elongated shaft to a peripheral edge, the tubular sleeve being radially self-centred guided by said peripheral edge, the throttle fluid communication means being an orifice drilled through the tubular sleeve and extending from an upstream orifice opening in the upstream chamber to a downstream orifice opening in the downstream chamber.

19. A nozzle assembly as set in claim 18 wherein the tubular sleeve is axially elongated, the throttle being drilled through a lateral wall of the tubular sleeve, the upstream orifice being arranged in an outer cylindrical face of the tubular sleeve and, the downstream orifice being arranged in an inner cylindrical face of the tubular sleeve.

20. A nozzle assembly as set in claim 19 wherein the collar is guided toward an upstream end of the tubular sleeve, the downstream opening of the throttle being toward a downstream end of the tubular sleeve, downstream the collar.

21. A nozzle assembly as set in claim 18 wherein, the tubular sleeve is provided with a multitude of fine through holes so that, the tubular sleeve provides, in use, pressure drop and, is also a fuel filter retaining foreign matters and particles flowing in the fuel.

22. A nozzle assembly as set in claim 18 wherein a downstream end of the tubular sleeve is bevelled so that an abutting portion of the tubular sleeve against the face of the nozzle body is reduced.

23. A nozzle assembly as set in claim 18 wherein the tubular sleeve is a thick disc-plate radially extending from the central hole, the throttle being drilled through the thickness of the tubular sleeve, its upstream orifice being arranged in an upper face of the tubular sleeve and, its downstream orifice being arranged in a lower face of the tubular sleeve.

24. A nozzle assembly as set in claim 23 wherein the lower face of the tubular sleeve is provided with a recess defining a circular bevelled protrusion, so that an abutting portion of the tubular sleeve is reduced.

25. A nozzle assembly as set in claim 23 wherein a face of the nozzle body against which abuts the tubular sleeve is provided with a circular bevelled protrusion so that an abutting portion of the tubular sleeve is reduced.

26. A nozzle assembly as set in claim 18 wherein the upstream orifice of the orifice has a larger section that the downstream orifice.

27. A nozzle assembly as set in claim 17 wherein the tubular sleeve is a thick disc-plate where the central hole larger than the main elongated shaft of the valve needle, the tubular sleeve radially extending from said hole to an outer peripheral face slidably guided and self-centred by an inner cylindrical face of the nozzle and wherein, the valve needle is provided with a radially extending face which outer edge is larger than the central hole of the tubular sleeve so that, the tubular sleeve is received in axial abutment against said radially extending face of the valve needle, the throttle fluid communication means comprising an orifice drilled through the thickness of said tubular sleeve and extending from an upper face to a lower face of the tubular sleeve.

28. A nozzle assembly as set in any claim 17 further comprising a biasing means arranged to axially bias the tubular sleeve downstream against the face of the nozzle body, or of the valve needle.

29. A nozzle assembly as set in claim 28 wherein said biasing means is a compression spring coiled around the main elongated shaft and compressed between the tubular sleeve and an upper radial face of the valve needle.

30. A nozzle assembly as set in claim 28 wherein the biasing mean is a spring compressed between the tubular sleeve and an inner face of the upstream chamber, the spring having a larger section upstream, where it is stuck against said inner face, than downstream, where it is in contact with the tubular sleeve.

31. A nozzle assembly as set in claim 17 wherein the throttle fluid communication means comprises a plurality of orifices provided through the tubular sleeve.

32. A fuel injector provided with a nozzle assembly as set in claim 17.
